(19) United States
(12) Patent Application Publication
(10) Pub. No.: US 2004/0058674 A1
(43) Pub. Date: Mar. 25, 2004

(54) Multi-homing and multi-hosting of wireless audio subsystems

(75) Inventor: John H. Yoakum, Cary, NC (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/247,158

(22) Filed: Sep. 19, 2002

(51) Int. Cl. H04M 3/42

(52) U.S. Cl. 455/416; 455/426.1

(57) ABSTRACT

The present invention provides for multi-hosting or multi-homing of wireless audio subsystems to one or more communications client systems to facilitate wireless, voice communications. For multi-hosting, the client system is capable of simultaneously hosting multiple, wireless audio subsystems to enable multi-party participation in communication events, such as conference calls and the like. Typically, the client system is associated with a circuit-switched or packet-switched telephony system, wherein a conference call can be effected between the participants in proximity to the client system using individual, wireless audio subsystems, such as headsets, all interacting equally with remote participants in the conference call. For multi-homing, multiple client systems can be placed at different locations, wherein the client systems cooperate with the audio subsystems when they are within a defined proximity of one another to facilitate a communication session between the audio subsystem and the proximate client system.

### FIELD OF THE INVENTION

The present invention relates to wireless communications, and in particular to providing wireless communications between one or more audio subsystems and one or more communications client systems.

### BACKGROUND OF THE INVENTION

Wireless headsets and like devices that facilitate voice communications are becoming commonplace. These headsets provide a bi-directional wireless link to a base device, which is further connected to and facilitates communications with a circuit-switched telephony network or a packet-switched multimedia communications network. Typically, each headset is linked to a common base device, wherein any given headset can only facilitate communications with a single base device. If there is a need for the headset to communicate with a different base device, significant reconfiguration is required.

Although the wireless headsets provide increased mobility and eliminate a wired connection with the base device, people often need to move from location to location and need to communicate on different communication systems in those different locations. Unfortunately, when moving from one location to another, a headset configured to operate in association with a first base device in the first location is generally not compatible with another base device in a second location. If the headset is compatible, significant reconfiguration is necessary to facilitate communications. The reconfiguration will likely destroy the configuration with the first base device, and will thus require the user to reconfigure the headset to talk to the first base device upon returning to the first location.

Additionally, headsets often allow users to control volume and other performance characteristics to customize the headset to the user. If the user has to change headsets or reconfigure the headset for a different base device, the customization settings must be reset or adjusted. Accordingly, there is a need for a communication system wherein wireless headsets can readily and automatically associate themselves with base devices in different locations to allow users to use a common headset in different locations.

In addition to the need for facilitating such mobility of headsets from location to location, there is a need for a communication system allowing headsets to be used in a conference setting, wherein people within a given conference room or area can use their respective headsets to facilitate bi-directional communications during a conference call. In a typical conference room setting, individual speaking characteristics and hearing capabilities result in many participants not being able to hear or be heard in an effective manner. Further, as participants in the conference call move around the conference room setting and interact with other people, white boards, and multimedia devices, their ability to hear and be heard continuously changes. As such, there is a need for a conference room setting wherein each of the participants can control audio levels on an individual basis. Additionally, the ability for individual participants to control their own mute functions is highly desirable.

### SUMMARY OF THE INVENTION

The present invention provides for multi-hosting or multi-homing of wireless audio subsystems to one or more communications client systems to facilitate wireless, voice communications. For multi-hosting, the client system is capable of simultaneously hosting multiple, wireless audio subsystems to enable multi-party participation in communication events, such as conference calls and the like. Typically, the client system is associated with a circuit-switched or packet-switched telephony system, wherein a conference call can be effected between the participants in proximity to the client system using individual, wireless audio subsystems, such as headsets, all interacting equally with remote participants in the conference call. For multi-homing, multiple client systems can be placed at different locations, wherein the client systems cooperate with the audio subsystems when they are within a defined proximity of one another to facilitate a communication session between the audio subsystem and the proximate client system.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a client system interacting with multiple audio subsystems according to one embodiment of the present invention.

FIG. 2 is a block representation of an audio subsystem configured to automatically be recognized by client systems in different locations according to one embodiment of the present invention.

FIG. 3 is a block representation of a client system according to one embodiment of the present invention.

FIG. 4 is a block representation of an audio subsystem according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides for multi-hosting or multi-homing of wireless audio subsystems to one or more communications client systems to facilitate wireless, voice communications. For multi-hosting, the client system is capable of simultaneously hosting multiple, wireless audio subsystems to enable multi-party participation in communication events, such as conference calls and the like. Typically, the client system is associated with a circuit-switched or packet-switched telephony system, wherein a conference call can be effected between the participants in proximity to the client system using individual, wireless audio subsystems, such as headsets, all interacting equally with remote participants in the conference call. The communications client system can be any voice-capable telephony or multimedia communications client, such as a properly enabled wired or wireless telephone, a multimedia personal computer or web based client, a personal digital assistant voice client, or any other communications client capable of reaching other parties via some from of communications network. Participants using the audio subsystems can control volume levels and audio characteristics on an individual basis. Further, the audio subsystems and the client system are configured to automatically establish a communication session once they are within an operable proximity.

For multi-homing, multiple client systems can be of the same or different client technologies and placed at different locations, wherein the client systems cooperate with the audio subsystems when they are within a defined proximity of one another to facilitate a communication session between the audio subsystem and the proximate client system. Again, recognition and establishment of the communication session between the audio subsystems and the proximate client system allows for individuals associated with the audio subsystems to roam from one location to the next and have a communication session established for them automatically. The multi-homing embodiment allows individuals to readily participate in communication sessions in different locations, utilizing the same or different client technologies, as well as establishing customized audio and acoustical configurations that remain in place regardless of location or client technology. In the multi-homing environment, it is possible that a single audio subsystem may be interacting with multiple clients of similar or different technologies in the same vicinity if the audio subsystem is enabled to have multiple simultaneous interactions or is able to interact on a first come first served basis. An example would be using the same headset on an office telephone, a mobile telephone, and a multimedia personal computer client, all of which happen to be on in an office at some instant in time. Further detail is provided below, wherein a multi-hosting embodiment is described followed by a multi-homing embodiment. Notably, these embodiments are discussed separately, but the operability for both multi-hosting and multi-homing can be provided in combination with one another.

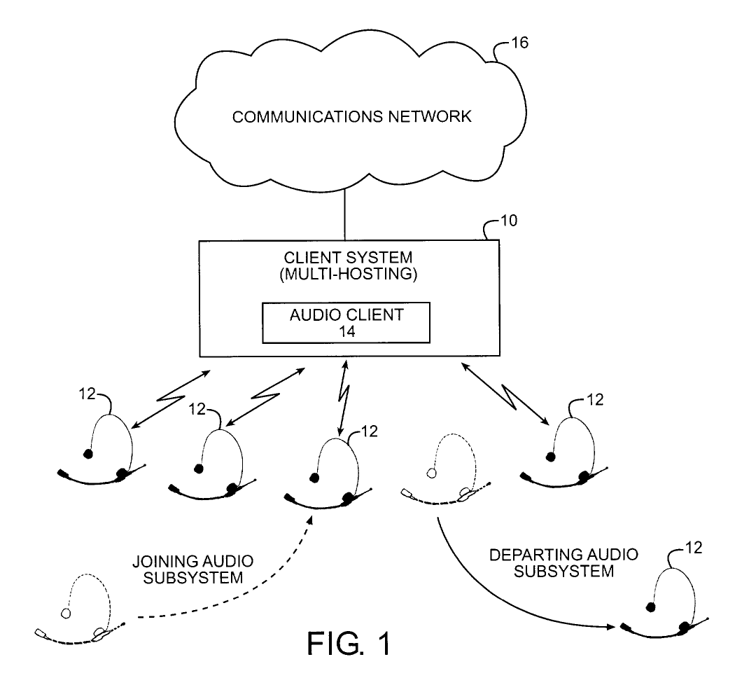

With reference to FIG. 1, a multi-hosting embodiment is described wherein a client system 10 is configured to facilitate wireless communications with a plurality of audio subsystems 12, which are illustrated as being full-duplex headsets capable of providing wireless communications with an audio client 14 of the client system 10. The client system 10 is preferably associated with a communications network 16 capable of providing wireless, packet- or circuit-switched communications with existing networks, such as a cellular network, Internet, public switched telephone network (PSTN), and the like. The client system 10 can be any type of telephone, mobile telephone, internet-based client, or communication client capable of session control and media transport. The audio subsystems 12 can be of many forms, one of the most likely being a small wirelessly linked personal headset with an integrated microphone and speaker system operating in association with a control system and transceiver electronics. This configuration allows participants to gather around a client system 10 and have individual audio interfaces with personal volume settings, muting, and the like, while participating in the same communication event. Depending on the complexity of the audio subsystem 12, various levels of signal processing, including equalization, may also be provided.

Preferably, the audio client 14 and the audio subsystems 12 are configured to automatically recognize one another and establish a wireless link between one another once the audio subsystem 12 is within an operable proximity to the audio client 14. For example, the audio client 14 may be configured to provide relatively limited communication coverage for a conference room setting, wherein when individuals wearing the audio subsystems 12 walk into the conference room, a wireless communication link can be established between the audio client 14 and the joining audio subsystem 12. For security purposes, each audio subsystem 12 may have a unique identification code and the audio client 14 may be configured to support communications only with authorized audio subsystems 12. Typically, the audio subsystems 12 will also need to recognize the audio client 14 to facilitate bi-directional communications. The client system 10 may be dynamically configured to change authorized participants from one conference to another. Those skilled in the art will recognize the various techniques for allowing the client system 10 and the audio subsystems 12 to identify and authenticate one another prior to facilitating a communication link supporting voice communications.

The client system 10 will preferably provide at a minimum all of the basic functionality of a traditional telephonic conferencing device, wherein the input/output interface for local participants will be the audio client 14, which supports wireless communications with the audio subsystems 12. The audio client 14 may also incorporate the appropriate signal processing circuitry to facilitate level control, echo cancellation, and audio feedback characteristics for all the local participants and the audio from the incoming telephony lines, channels, or sessions. Further, the audio client 14 will provide the appropriate mixing and level equalization for the lines, channels, and subsystems along with that for each of the audio subsystems 12. The mixing is required because the individual audio subsystems 12 for participants in the conference room must be mixed together to varying degrees prior to delivering signals back to each of the audio subsystems 12 and over the line, channel, or session to those systems and participants not in the local vicinity of the client system 10. Typically, the audio client 14 will mix all of the audio received from the audio subsystems 12 for delivery to the remote participants, and if multiple lines are involved, include audio from those lines, channels, or sessions.

For participants using the audio subsystems 12, the audio client 14 may or may not include the voice input from the participant associated with a particular audio subsystem 12, or may provide voice at varying levels from that at a point lower than the other participants to a level higher than the other participants, depending on the desires of the individual. Given the mobility of the audio subsystems 12 with respect to the client system 10, local participants can readily move about the client system 10 without negatively impacting audio in either direction. Further, participants joining the conference locally can join automatically, and those departing the conference may depart automatically, wherein the communication for the joining participant will initiate automatically and for the departing participant will cease automatically. Individual users of the client system 10 as well as the audio subsystems 12 are preferably able to dynamically enter data to control which audio subsystems 12 can communicate with each client system 10.

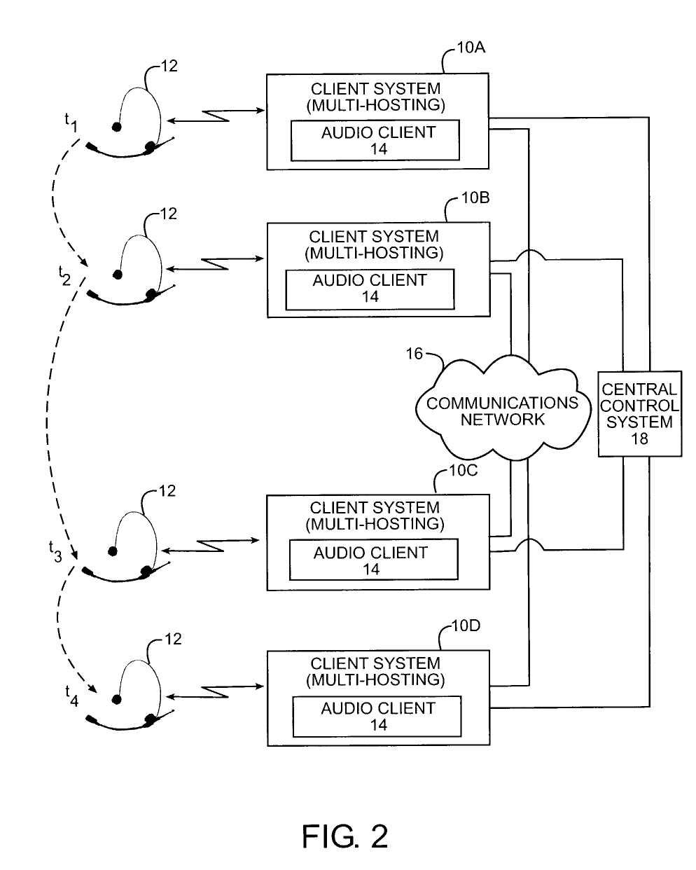

With reference to FIG. 2, a multi-homing embodiment is illustrated, wherein multiple client systems 10A-10D are located at different locations and operate under the control of a central control system 18. Each client system 10A-10D is coupled to the telephone network 16, and can automatically establish wireless communication links with an audio subsystem 12 once the audio subsystem 12 and the client system 10A-10D are within an operable proximity of one another. For example, at time t₁, audio subsystem 12 is within an operable proximity of client system 10A and a first communication link is established to support a communication session. When the audio subsystem 12 is moved to a second location within an operable proximity to client system 10B at time t₂, a second communication link is established with client system 10B to support a communication session, and so forth. Typically, the communication link between the audio subsystem 12 and the client system 10A is broken after the audio subsystem 12 leaves the operable proximity about client system 10A prior to entering into operable proximity of client system 10B. As such, the audio subsystem 12 can move from one client system 10A-10D to another, and a communication link is automatically established once the audio subsystem 12 is within an operable proximity, assuming the audio subsystem 12 and the client system 10A-10D are authorized to establish the communication link. In one embodiment, an audio subsystem 12, such as a headset, can roam between similar but geographically diverse client systems 10A-10D in a coordinated network implementation. In another embodiment, the same headset can roam between a mobile telephone, Session Initiation Protocol (SIP) client, and office telephone, as well as some conference room telephones, all of which act as client systems 10. In the latter case, the actual client technologies are dissimilar and no central coordination exists. Further, the invention allows for simultaneous communication links between an audio subsystem 12 and multiple client systems 10.

For authorization, the central control system 18 can download operable identifications or codes to each of the respective client systems 10A-10D to identify the audio subsystems 12 with which communication links can be established. Further, the individual client systems 10A-10D can communicate with the audio subsystems 12 to provide configuration information for authentication and identify client systems 10A-10D with which the audio subsystem 12 can communicate. Again, those skilled in the art will recognize various techniques with which to control access and provide authentication for secured communications between the audio subsystems 12 and the client systems 10A-10D.

By allowing an individual to use the same audio subsystem 12 with many different client systems 10 in a seamless fashion or all at the same time, the need for the individual to use different audio subsystems 12 is eliminated, thus providing a common set of audio settings and characteristics customized to the participant when moving between client systems 10A-10D. The use of an audio client 14 in association with a client system 10 allows a common audio subsystem 12 to efficiently integrate with disparate communication technologies provided by different client systems 10, sequentially or simultaneously.

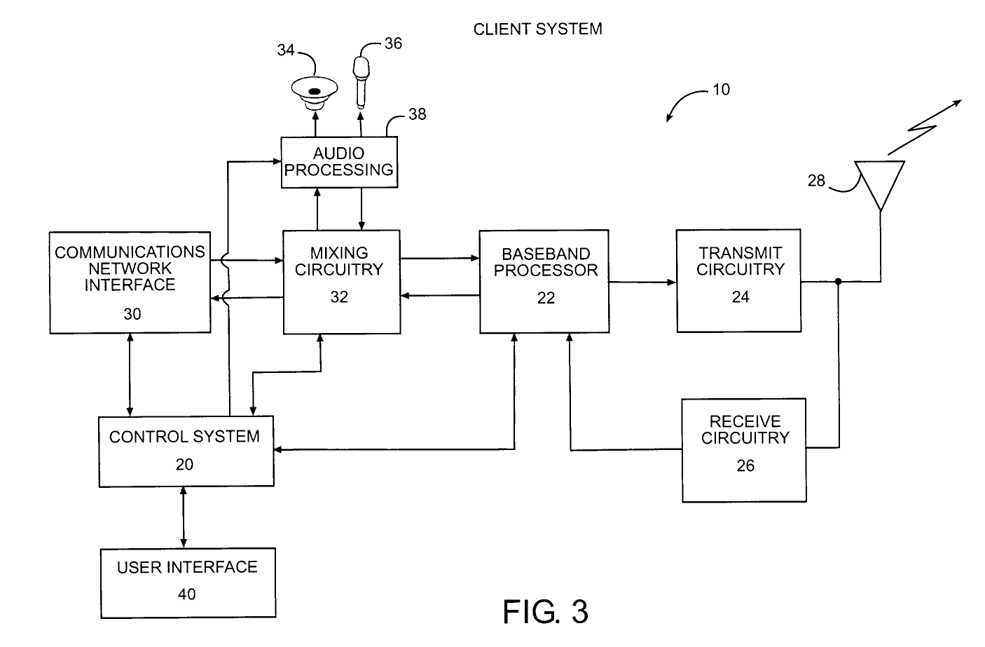

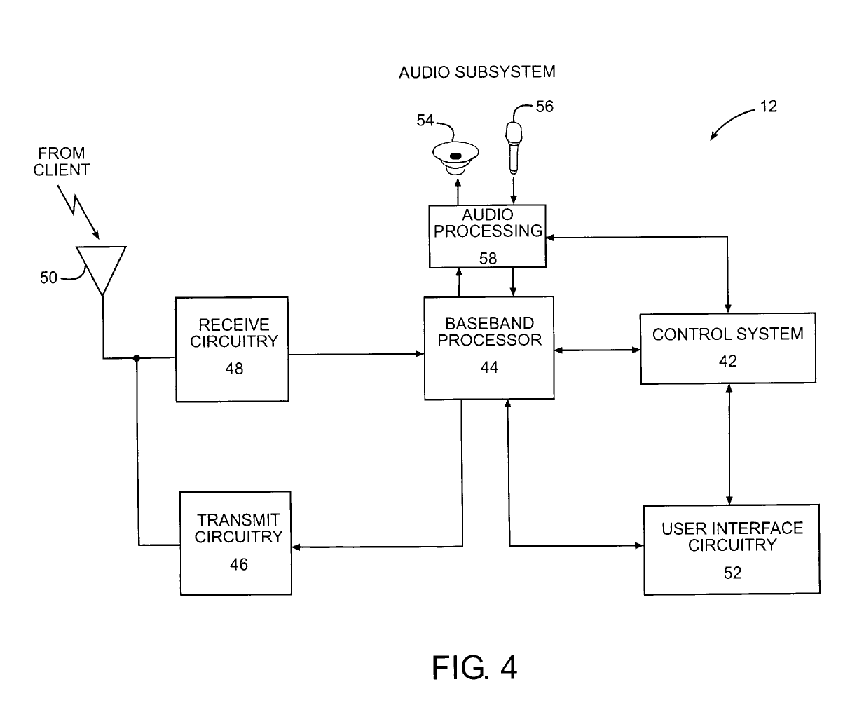

Next, a high level overview of the audio subsystems and client systems of the present invention is provided with reference to FIGS. 3 and 4. In the preferred embodiments, the client systems 10 are configured to automatically recognize authorized audio subsystems 12 that come within an operable range, and establish a wireless communication link to facilitate half- or full-duplex voice communications. An exemplary communication technology providing automatic recognition for limited or short-range communication is referred to as Bluetooth. In the preferred embodiment, the client systems 10 and the audio subsystems 12 communicate according to the Bluetooth Communication specification and associated protocols. Automatic recognition and device authentication are also made possible using Bluetooth. Those skilled in the art will recognize the numerous other standard and proprietary communication technologies capable of being used to implement the present invention.

Turning first to FIG. 3, a client system 10 with an integrated audio client 14 configured according to one embodiment of the present invention is illustrated. To facilitate wireless communications with the audio subsystems 12, the client system 10 generally includes a control system 20, a baseband processor 22, transmit circuitry 24, receive circuitry 26, and one or more antennas 28. The client system 10 will also include a communications network interface 30, mixing circuitry 32, speaker 34, microphone 36, audio processing circuitry 38, and a user interface 40.

The receive circuitry 26 receives radio frequency signals through antenna 28 bearing information from one or more remote transmitters provided by audio subsystems 12. Preferably, a low noise amplifier and a filter (not shown) cooperate to amplify and remove broadband interference from the signal for processing. Downconversion and digitization circuitry (not shown) will then downconvert the filtered, received signal to an intermediate or baseband frequency signal, which is then digitized into one or more digital streams.

The received information may include data and control information. The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) and application specific integrated circuits (ASICs) or software algorithms. The received information is then sent to the mixing circuitry 32, which will mix the received audio signals with audio signals received from other audio subsystems 12 communicating with the client system 10 and any other conference signals provided via the communications network 16 as necessary and send the resultant mix of signals to the communications network interface 30 for delivery across the communications network 16. The resultant mix of signals may also be mixed with incoming signals for the communications network 16 and delivered to the speaker 34 under control of the audio processing circuitry 38. In such a case, the audio processing circuitry 38 will convert the audio signals to an analog format and amplify the signals for audible playback via the speaker 34.

On the transmit side, the mixing circuitry 32 receives voice signals from the communications network interface 30 and signals received from the other participating audio subsystems 12 from the baseband processor 22 and mixes the signals to create a mixed signal for delivery back to the baseband processor 22, which encodes the mixed signal for transmission. Notably, the mixing function may be provided in the baseband processing. Further, the communications network interface 30 and mixing circuitry 32 may be configured to convert analog signals from the communications network 16 to a digital format corresponding to the baseband processor 22. The mixed signal is output to the transmit circuitry 24 from the baseband processor 22, where it is modulated by a carrier signal having a desired transmit frequency or frequencies. A power amplifier (not shown) will amplify the modulated carrier signal to a level appropriate for transmission, and deliver the modulated carrier signal to one or more antennas 28 through a matching network (not shown) for wireless transmission to the audio subsystems 12. The user interface 40 may be used to provide basic telephonic and conferencing control of the client system 10, such as dialing, muting, level control, and the like.

With reference to FIG. 4, an audio subsystem 12 configured according to one embodiment of the present invention is illustrated. Similarly to the client system 10, the audio subsystem 12 will include a control system 42, a baseband processor 44, transmit circuitry 46, receive circuitry 48, one or more antennas 50, user interface circuitry 52, a speaker 54, and microphone 56, and audio processing circuitry 58. The receive circuitry 48 receives radio frequency signals through one or more antennas 50 bearing voice information from the client system 10. Preferably, a low noise amplifier and a filter (not shown) cooperate to amplify and remove broadband interference from the signal for processing. Downconversion and digitization circuitry (not shown) will then downconvert the filtered, received signal to an intermediate or baseband frequency signal, which is then digitized into a digital stream. The baseband processor 44 processes the digitized received signal to extract the information or data bits conveyed in the received signal. This processing typically comprises demodulation, decoding, and error correction operations. The resultant signal is converted to an analog voice signal, processed, and amplified before being sent to speaker 54 via the audio processing circuitry 58. The baseband processor 44 is generally implemented in one or more digital signal processors (DSPs) and application specific integrated circuits (ASICs) or software algorithms.

For transmission, voice signals picked up by the microphone 56 are digitized by the audio processing circuitry 58 and sent to the baseband processor 44 for encoding for transmission. The encoded data is output to the transmit circuitry 46, where it is used by a modulator to modulate a carrier signal that is at a desired transmit frequency or frequencies. A power amplifier (not shown) will amplify the modulated carrier signal to a level appropriate for transmission, and deliver the modulated carrier signal to the one or more antennas 50 through a matching network (not shown).

Based on user input received via the user interface circuitry 52, the control system 42 can control the audio processing circuitry 58 to provide level control, equalization, microphone muting, and the like for the incoming or outgoing signals. These settings may be stored and used when communicating with any client system 10.

Although the above embodiments provide significant processing in the digital domain, those skilled in the art will recognize that analog embodiments are possible and considered within the scope of the present invention. Those skilled in the art will recognize improvements and modifications to the preferred embodiments of the present invention. All such improvements and modifications are considered within the scope of the concepts disclosed herein and the claims that follow.

What is claimed is:

1. A client system supporting wireless communications with audio subsystems comprising:
a) a network interface adapted to facilitate telephony communications;
b) a wireless communication interface adapted to facilitate wireless communications with a plurality of audio subsystems; and
c) control and processing circuitry adapted to:
i) mix local voice signals received from the audio subsystems via the wireless communication interface to create a mixed signal for transmission over a telephony network via the network interface; and
ii) direct remote voice signals received from the communications network via the network interface to the wireless communication interface for transmission to each of the audio subsystems.

2. The client system of claim 1 wherein the control and processing circuitry is further adapted to mix signals from at least select ones of the audio subsystems with the remote voice signals prior to directing a resultant mixed signal to the wireless communication interface for transmission to the each of the audio subsystems.

3. The client system of claim 1 wherein the control and processing circuitry is further adapted to cooperate with the wireless communication interface to automatically recognize a joining audio subsystem coming within an operable communication range and establish a communication link with the joining audio subsystem.

4. The client system of claim 3 wherein the control and processing circuitry is further adapted to:
a) receive authorization information from each audio subsystem via the wireless communication interface; and
b) establish a communication link with each audio subsystem only if each audio subsystem is authorized.

5. The client system of claim 1 further comprising a speaker and microphone associated with the control and processing circuitry to provide traditional telephonic conferencing.

6. A client system supporting wireless communications with audio subsystems comprising:
a) a network interface adapted to facilitate telephony communications;
b) a wireless communication interface adapted to facilitate wireless communications with a plurality of audio subsystems; and
c) control and processing circuitry adapted to cooperate with the wireless communication interface and the network interface to:
i) automatically recognize a joining audio subsystem coming within an operable communication range and establish a communication link with the joining audio subsystem;
ii) direct local voice signals received from the joining audio subsystem via the wireless communication interface to the network interface for transmission over a telephony network; and
iii) direct remote voice signals received from the telephony network via the network interface to the wireless communication interface for transmission to the joining audio subsystem.

7. The client system of claim 6 wherein the control and processing circuitry is further adapted to break the communication link after the joining audio subsystem departs from the operable communication range.

8. The client system of claim 6 wherein the control and processing circuitry is further adapted to:
a) receive authorization information from the joining audio subsystem via the wireless communication interface; and
b) establish the communication link with the joining audio subsystem only if the joining audio subsystem is authorized.

9. The client system of claim 6 wherein the wireless communication interface is adapted to facilitate wireless communications with the plurality of audio subsystems simultaneously and the control and processing circuitry is further adapted to:
a) mix the local voice signals received from the audio subsystems via the wireless communication interface to create a mixed signal for transmission over a telephony network via the network interface; and
b) direct the remote voice signals received from the telephony network via the network interface to the wireless communication interface for transmission to each of the audio subsystems.

10. The client system of claim 9 wherein the control and processing circuitry is further adapted to mix signals from at least select ones of the audio subsystems with the remote voice signals prior to directing a resultant mixed signal to the wireless communication interface for transmission to the each of the audio subsystems.

11. A communication system comprising:
a) a plurality of audio subsystems adapted to facilitate wireless communications; and
b) a client system comprising:
i) a network interface adapted to facilitate telephony communications;
ii) a wireless communication interface adapted to simultaneously facilitate wireless communications with one or more of the plurality of audio subsystems; and
iii) control and processing circuitry adapted to:
(1) mix local voice signals received from the audio subsystems via the wireless communication interface to create a mixed signal for transmission over a communications network via the network interface; and
(2) direct remote voice signals received from the communications network via the network interface to the wireless communication interface for transmission to each of the audio subsystems.

12. The communication system of claim 11 wherein at least one of the audio subsystems comprises:
a) a wireless communication interface;
b) a speaker;
c) a microphone; and
d) audio processing circuitry associated with the wireless communication interface, speaker, and microphone to facilitate full duplex voice communications.

13. The communication system of claim 12 wherein the audio processing circuitry of the audio subsystem is adapted to provide at least one of the functions consisting of level control, muting, and equalization for voice signals used to drive the speaker.

14. The communication system of claim 11 wherein the control and processing circuitry is further adapted to mix signals from at least select ones of the audio subsystems with the remote voice signals prior to directing a resultant mixed signal to the wireless communication interface for transmission to each of the audio subsystems.

15. The communication system of claim 11 wherein the control and processing circuitry is further adapted to cooperate with the wireless communication interface to automatically recognize a joining audio subsystem coming within an operable communication range and establish a communication link with the joining audio subsystem.

16. The communication system of claim 15 wherein the control and processing circuitry is further adapted to:
a) receive authorization information from each audio subsystem via the wireless communication interface; and
b) establish a communication link with each audio subsystem only if each audio subsystem is authorized.

17. The communication system of claim 11 further comprising a speaker and microphone associated with the control and processing circuitry to provide traditional telephonic conferencing.

18. A communication system supporting wireless communications with audio subsystems comprising:
a) a plurality of audio subsystems adapted to facilitate wireless communications; and
b) a client system comprising:
i) a network interface adapted to facilitate telephony communications;
ii) a wireless communication interface adapted to facilitate wireless communications with a plurality of audio subsystems; and
iii) control and processing circuitry adapted to cooperate with the wireless communication interface and the network interface to:
(1) automatically recognize a joining audio subsystem coming within an operable communication range and establish a communication link with the joining audio subsystem;
(2) direct local voice signals received from the joining audio subsystem via the wireless communication interface to the network interface for transmission over a communications network; and
(3) direct remote voice signals received from the communications network via the network interface to the wireless communication interface for transmission to the joining audio subsystem.

19. The communication system of claim 18 further comprising a plurality of client systems wherein the audio subsystems can communicate with each of the client systems when within an operable proximity.

20. The communication system of claim 19 wherein at least two of the client systems are disparate from one another.

21. The communication system of claim 19 wherein the plurality of audio subsystems are capable of simultaneously establishing communication links with at least two of the plurality of client systems.

22. The communication system of claim 18 wherein the control and processing circuitry is further adapted to break the communication link after the joining audio subsystem departs from the operable communication range.

23. The communication system of claim 18 wherein the control and processing circuitry is further adapted to:
a) receive authorization information from the joining audio subsystem via the wireless communication interface; and
b) establish the communication link with the joining audio subsystem only if the joining audio subsystem is authorized.

24. The communication system of claim 18 wherein the wireless communication interface is adapted to facilitate wireless communications with a plurality of audio subsystems simultaneously and the control and processing circuitry is further adapted to:
a) mix the local voice signals received from the audio subsystems via the wireless communication interface to create the mixed signal for transmission over the communications network via the network interface; and
b) direct the remote voice signals received from the communications network via the network interface to the wireless communication interface for transmission to each of the audio subsystems.

25. The communication system of claim 24 wherein the control and processing circuitry is further adapted to mix signals from at least select ones of the audio subsystems with the remote voice signals prior to directing a resultant mixed signal to the wireless communication interface for transmission to the each of the audio subsystems.
